(19) United States
(12) Patent Application Publication
(10) Pub. No.: US 2006/0109268 A1
(43) Pub. Date: May 25, 2006

(54) System and method for generating rendering data associated with a 3-D image

(76) Inventors: Joshua Napoli, Arlington, MA (US); Won-Suk Chun, Cambridge, MA (US); Gregg E. Favalora, Arlington, MA (US); Deirdre M. Hall, Beverly, MA (US)

Correspondence Address: CANTOR COLBURN, LLP, 55 GRIFFIN ROAD SOUTH, BLOOMFIELD, CT, 06002, US

(21) Appl. No.: 11/177,618

(22) Filed: Jul. 8, 2005

Related U.S. Application Data
(60) Provisional application No. 60/629,734, filed on Nov. 19, 2004.

(51) Int. Cl. G06T 17/00

(52) U.S. Cl. 345/424

(57) ABSTRACT

A system and a method for generating rendering data associated with a 3-D image are provided. The system includes a 3-D API configured to generate a first 3-D data message indicative of one or more voxels in a first 3-D image from first 3-D image data. The system further includes a 3-D rendering software driver configured to receive the first 3-D data message from the 3-D API. The system further includes a 2-D rendering software driver operably communicating with a 3-D rendering software driver and a rendering device. The 3-D rendering software driver is configured to generate at least a first rendering command identifying one or more voxels in a slice of the first 3-D image. The 3-D rendering software driver sends the first rendering command to the 2-D rendering software driver. The 2-D rendering software driver is configured to generate at least a first 2-D array of data based on the rendering command utilizing the rendering device.

### CROSS REFERENCE TO RELATED APPLICATIONS

The application claims the benefit of U.S. Provisional application, Ser. No. 60/629,734, filed Nov. 19, 2004, the contents of which are incorporated herein by reference thereto.

### BACKGROUND OF THE INVENTION

Computer systems have been developed for generating 3-D images on display devices. Generally, a computer with 3-D rendering hardware transmits a command to 3-D rendering software being executed on a processor in the display device. However, because the 3-D rendering software cannot communicate back to the 3-D rendering hardware on the computer, a general-purpose processor in the display device is utilized to generate rendering data. A drawback with the foregoing system configuration is that a rate at which rendering data is generated at the display device is relatively slow. As a result, the presentation of a plurality of 3-D images by the display device may be undesirably “choppy” or discontinuous.

Accordingly, the inventors herein have recognized a need for an improved system for generating rendering data at a faster rate.

### BRIEF DESCRIPTION OF THE INVENTION

A system for generating rendering data associated with a 3-D image in accordance with an exemplary embodiment is provided. The system includes a 3-D application programming interface (API) configured to generate a first 3-D data message indicative of one or more voxels in a first 3-D image from first 3-D image data. The system further includes a 3-D rendering software driver configured to receive the first 3-D data message from the 3-D API. The system further includes a 2-D rendering software driver operably communicating with a 3-D rendering software driver and a rendering device. The 3-D rendering software driver is configured to generate at least a first rendering command identifying one or more voxels in a slice of the first 3-D image. The 3-D rendering software driver sends the first rendering command to the 2-D rendering software driver. The 2-D rendering software driver is configured to generate at least a first 2-D array of data based on the rendering command utilizing the rendering device.

A method for generating rendering data associated with a 3-D image in accordance with an exemplary embodiment is provided. The method includes generating a first 3-D data message indicative of one or more voxels in a first 3-D image from first 3-D image data, utilizing a 3-D API. The method further includes generating at least a first rendering command identifying one or more voxels in a slice of the first 3-D image based on the first 3-D message, utilizing a 3-D rendering software driver. The method further includes generating at least a first 2-D array of data based on the first rendering command utilizing the 2-D rendering software driver and a rendering device.

An article of manufacture in accordance with another exemplary embodiment is provided. The article of manufacture includes a computer storage medium having a computer program encoded therein for generating rendering data associated with a 3-D image. The computer storage medium includes code for a 3-D API that generates a first 3-D data message indicative of one or more voxels in a first 3-D image from first 3-D image data, utilizing a 3-D API. The computer storage medium further includes code for a 3-D rendering software driver that generates at least a first rendering command identifying one or more voxels in a slice of the first 3-D image based on the first 3-D message. The computer storage medium further includes code for a 2-D rendering software driver that generates at least a first 2-D array of data based on the first rendering command.

### BRIEF DESCRIPTION OF THE DRAWINGS

FIG. 1 is a block diagram of a system for rendering data associated with a 3-D image including a client computer and a 3-D display device in accordance with an exemplary embodiment;

FIG. 2 is a block diagram of a software architecture utilized in the client computer illustrated in FIG. 1;

FIG. 3 is a block diagram of a software architecture utilized in the 3-D display device illustrated in FIG. 1;

FIGS. 4-6 are flowcharts of a method for generating rendering data associated with a 3-D image;

FIG. 7 is a block diagram of a system for rendering data associated with a 3-D image including a client computer and a 3-D display device in accordance with another exemplary embodiment;

FIG. 8 is a block diagram of a software architecture utilized in the client computer illustrated in FIG. 7; and

FIGS. 9-11 are flowcharts of a method for generating rendering data associated with a 3-D image.

### DETAILED DESCRIPTION OF THE INVENTION

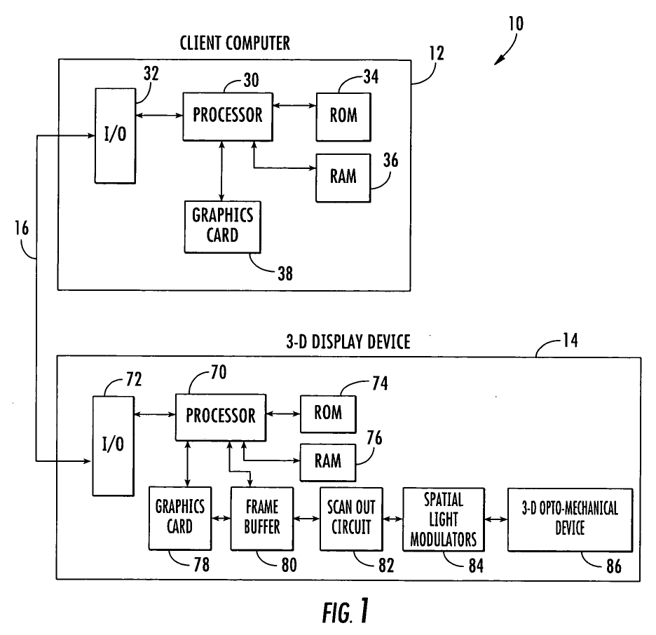

Referring to FIG. 1, a system 10 for generating rendering data associated with 3-D image is illustrated. The system 10 includes a client computer 12, a 3-D display device 14, and a communication bus 16.

The client computer 12 is provided to execute software algorithms for generating 3-D image data associated with one or more 3-D images. The client computer 12 includes of a processor 30 operably coupled to an input/output (I/O) interface 32, a read-only memory (ROM) 34, a random-access memory (RAM) 36, and a rendering device such as a graphics card 38. The I/O interface 32 is operably coupled between the processor 30 and a high-speed communication bus 16. The I/O interface 32 routes 3-D image data from the processor 30 through the communication bus 16 to the 3-D display device 14. The ROM 34 and the RAM 36 are provided to store software algorithms utilized by the client computer 12. The graphics card 38 is provided to perform calculations for generating rendering data. In an alternate embodiment, the graphics card 38 can be replaced with any rendering device that is configured to generate rendering data. For example, the rendering device could comprise one or more of a microchip from a graphics chipset, a CPU, a DSP executing software-based rendering algorithms, or the like.

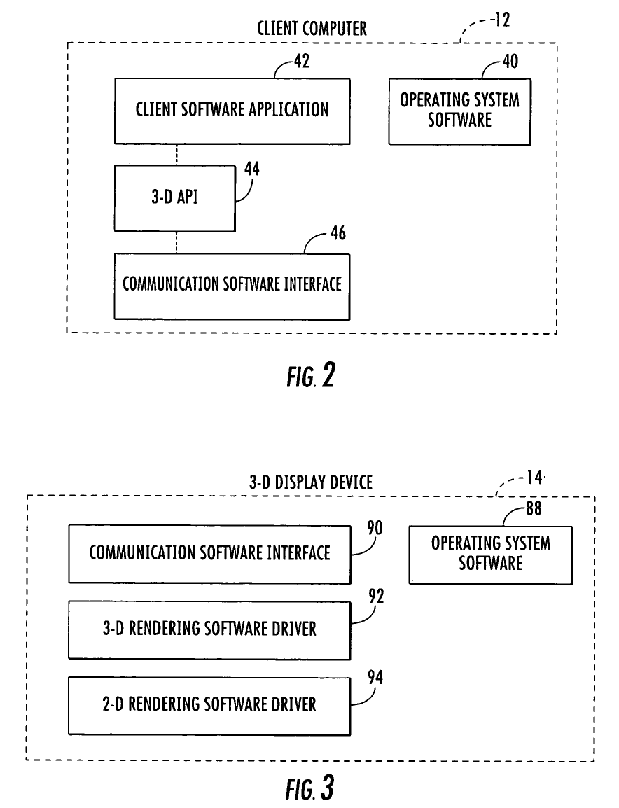

Referring to FIG. 2, the processor 30 executes the following software algorithms: (i) an operating system software 40, (ii) a client software application 42, (iii) a 3-D API 44, and (iv) a communication software interface 46. The operating system software 40 facilitates execution of the client software application 42, the 3-D API 44, and the communication software interface 46. In one embodiment, the operating system software 40 comprises a Linux operating system. In alternate embodiments, the operating system software 40 may comprise the Window XP operating system, the Windows CE operating system, the VxWorks operating system, the QNX operating system, or the like, for example. The client software application 42 is provided to generate 3-D image data representing a 3-D image. The 3-D API 44 is provided to format the 3-D image data into one or more formatted 3-D data messages for transmission through the communication bus 16. The communication software interface 46 is provided to induce the I/O interface 32 to transmit formatted 3-D data messages from the client computer 12 through the communication bus 16.

Referring to FIG. 1, the communication bus 16 is provided transfer data messages between the client computer 12 and the 3-D display device 14. In one embodiment, the communication bus 16 comprises a PCX communication bus. Of course, in alternate embodiments, the communication bus 16 can comprise any high-speed bus capable of transmitting data between the computer 12 and the 3-D display device 14.

The 3-D display device 14 is provided to generate rendering data based on received formatted 3-D data messages and to display 3-D images thereon using the rendering data. The 3-D display device 14 includes a processor 70 operably coupled to an I/O interface 72, a ROM 74, a ROM 76, a graphics card 78, a frame buffer 80, a scan-out circuit 82, optoelectronic devices such as spatial light modulators 84, and a 3-D opto-mechanical device 86. The I/O interface 72 is operably coupled between the processor 70 and the communication bus 16. The I/O interface 72 routes data received from the communication bus 16 to the processor 70. The ROM 74 and the RAM 76 are provided to store software algorithms utilized by the 3-D display device 14. The graphics card 78 is provided to perform calculations for generating rendering data, as will be described in greater detail below. In an alternate embodiment, the graphics card 78 can be replaced with any rendering hardware that is configured to generate rendering data. The frame buffer 80 is provided to store rendering data therein. The scan-out circuit 82 is provided to read the rendering data stored within the frame buffer 80 and to transmit the data to the spatial light modulators 84. The spatial light modulators 84 are provided to emit light based upon the rendering data. In alternate embodiments of the system 10, other types of optoelectronic devices could be utilized instead of the spatial light modulators, such as an array of light sources that are self-modulating (e.g., a rotating emissive panel of blinking LEDs) or a fixed light source that is modulated by a fast spatial light modulator device. Further, for example, optoelectronic devices described in U.S. Pat. Nos. 6,544,430, 4,983,031, and 5,172,266 that are incorporated herein by reference, could be utilized instead of spatial light modulators 84. In one embodiment, the light from the spatial light modulators 84 is utilized by the 3-D opto-mechanical device 86 to display 3-D images.

The 3-D opto-mechanical device 86 is provided to display images thereon. In one embodiment, the device 86 comprises a multi-planar volumetric display device. For example, the device 86 can comprise the multi-planar volumetric display device taught in U.S. Pat. No. 6,554,430 that is incorporated herein by reference. In another embodiment, the device 86 can comprise a holographic display device. For example, the device 86 can comprise the holographic display device taught in U.S. Pat. No. 5,172,251 that is incorporated herein by reference. In another embodiment, the device 86 comprises a multi-view or panoramagram display device. For example, the device 86 can comprise the multi-view or panoramagram display device taught in U.S. Pat. No. 6,850,210 that is incorporated herein by reference.

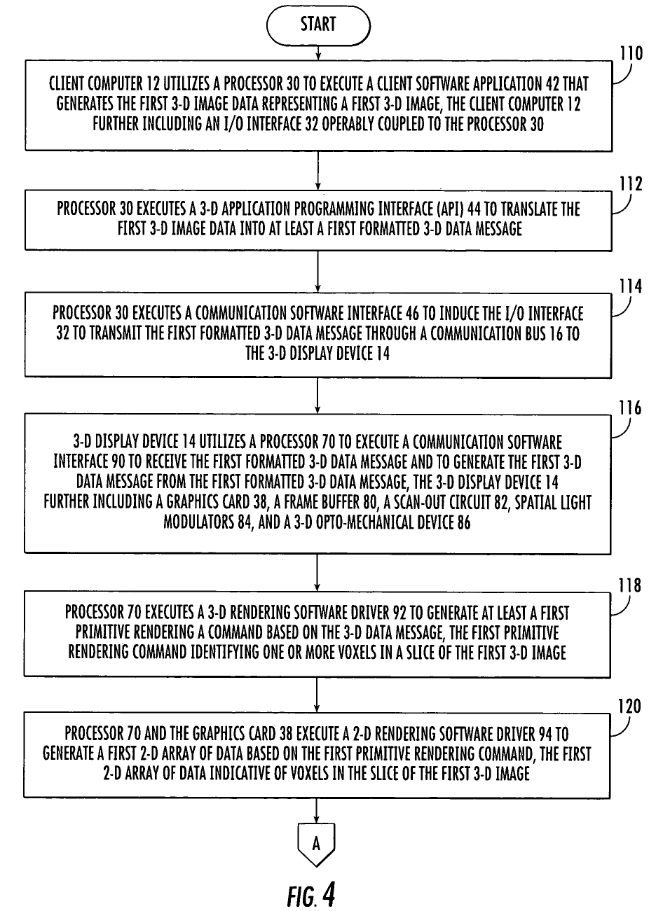

Referring to FIG. 3, the processor 70 executes the following software algorithms: (i) an operating system software 88, (ii) a communication software interface 90. The processor 70 and the graphics card 78 cooperatively execute a 3-D rendering software driver 92 and a 2-D rendering software driver 94. The operating system software 88 facilitates execution of the communication software interface 90, the 3-D rendering software driver 92, and the 2-D rendering software driver 94. In one embodiment, the operating system software 88 comprises a Linux operating system. In alternate embodiments, the operating system software 88 may comprise the Window XP operating system, the Windows CE operating system, the VxWorks operating system, the QNX operating system, or the like, for example. The communication software interface 90 is provided to induce the I/O interface 72 to receive data messages from the communication bus 16 and to transfer the data messages to the processor 70. The 3-D rendering software driver 92 is provided to generate primitive rendering commands that identifies one or more voxels in a slice of a 3-D image based upon 3-D data messages received by the 3-D display device 14. For example, in one embodiment, the primitive rendering commands can comprise OpenGL commands or the like. In the one embodiment, the primitive rendering commands can perform at least one or more of the following tasks: (i) render a list of triangular entities, (ii) load a texture map for use with other rendering commands, (iii) load a rendered image into the frame buffer 80, and (iv) transform a list of 3-D vertices to new 3-D locations where the 3-D vertices could be used to define triangular entities. The 2-D rendering software driver 94 is provided to generate a 2-D array of data based on each of the primitive rendering commands generated by the 3-D rendering driver 92 that is temporally stored in the frame buffer 80.

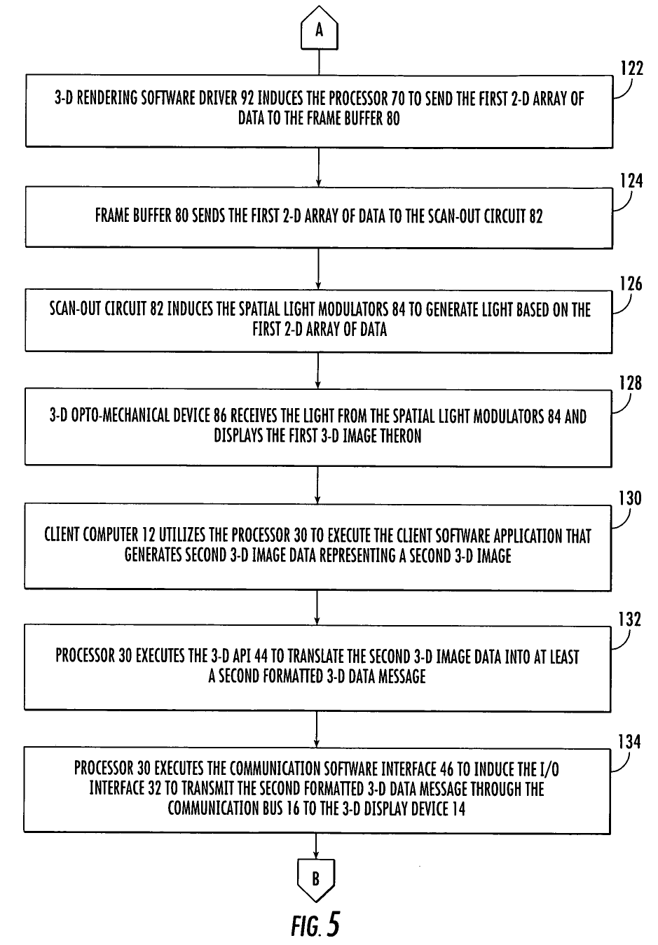

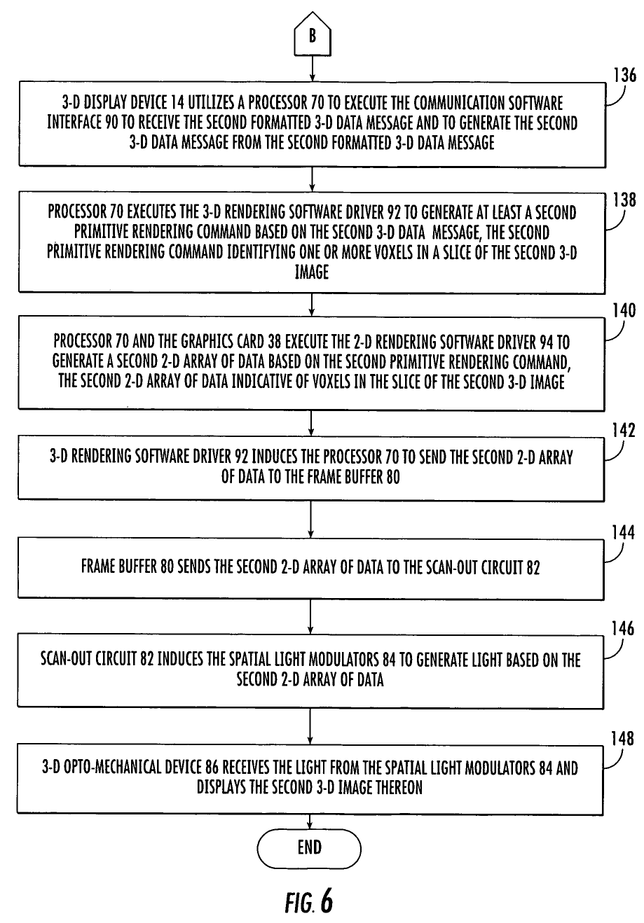

Referring to FIGS. 4-6, a method for generating rendering data associated with 3-D images will now be explained. The method can be implemented utilizing software algorithms executed in the system 10 described above.

At step 110, the client computer 12 utilizes a processor 30 to execute a client software application 42 that generates first 3-D image data representing a first 3-D image. The client computer 12 further includes the I/O interface 32 operably coupled to the processor 30.

Next at step 112, the processor 30 executes a 3-D API 44 to translate the first 3-D image data into at least a first formatted 3-D data message.

Next at step 114, the processor 30 executes a communication software interface 46 to induce the I/O interface 32 to transmit the first formatted 3-D data message through a communication bus 16 to the 3-D display device 14.

Next at step 116, the 3-D display device 14 utilizes a processor 70 to execute a communication software interface 90 to receive the first formatted 3-D data message and to generate the first 3-D data message from the first formatted 3-D data message. The 3-D display device 14 includes the graphics card 38, the frame buffer 80, the scan-out circuit 82, spatial light modulators 84, and the 3-D opto-mechanical device 86.

Next at step 118, the processor 70 executes a 3-D rendering software driver 92 to generate at least a first primitive rendering command based on the 3-D data message, the first primitive rendering command identifying one or more voxels in a slice of the first 3-D image.

Next at step 120, the processor 70 and the graphics card 38 execute a 2-D rendering software driver 94 to generate a first 2-D array of data based on the first primitive rendering command. The first 2-D array of data is indicative of voxels in the slice of the first 3-D image. A methodology for implementing step 120 is disclosed in U.S. Pat. No. 6,888,545 that is incorporated herein by reference.

Next at step 122, the 3-D rendering software driver 92 induces the processor 70 to send the first 2-D array of data to the frame buffer 80.

Next at step 124, the frame buffer 80 sends the first 2-D array of data to the scan-out circuit 82.

Next at step 126, the scan-out circuit 82 induces the spatial light modulators 84 to modulate light based on the first 2-D array of data.

Next at step 128, the 3-D opto-mechanical device 86 receives the light from the spatial light modulators 84 and displays the first 3-D image thereon.

Next at step 130, the client computer 12 utilizes the processor 30 to execute the client software application that generates second 3-D image data representing a second 3-D image.

Next at step 132, the processor 30 executes the 3-D API 44 to translate the second 3-D image data into at least a second formatted 3-D data message.

Next at step 134, the processor 30 executes the communication software interface 46 to induce the I/O interface 32 to transmit the second formatted 3-D data message through the communication bus 16 to the 3-D display device 14.

Next at step 136, the 3-D display device 14 utilizes a processor 70 to execute the communication software interface 90 to receive the second formatted 3-D data message and to generate the second 3-D data message from the second formatted 3-D data message.

Next at step 138, the processor 70 executes the 3-D rendering software driver 92 to generate at least a second primitive rendering command based on the second 3-D data message. The second primitive rendering command identifies one or more voxels in a slice of the second 3-D image.

Next at step 140, the processor 70 and the graphics card 38 execute the 2-D rendering software driver 94 to generate a second 2-D array of data based on the second primitive rendering command. The second 2-D array of data is indicative of voxels in the slice of the second 3-D image.

Next at step 142, the 3-D rendering software driver 92 induces the processor 70 to send the second 2-D array of data to the frame buffer 80.

Next at step 144, the frame buffer 80 sends the second 2-D array of data to the scan-out circuit 82.

Next at step 146, the scan-out circuit 82 induces the spatial light modulators 84 to generate light based on the second 2-D array of data.

Next at step 148, the 3-D opto-mechanical device 86 receives the light from the spatial light modulators 84 and displays the second 3-D image thereon. After step 148, the method is exited.

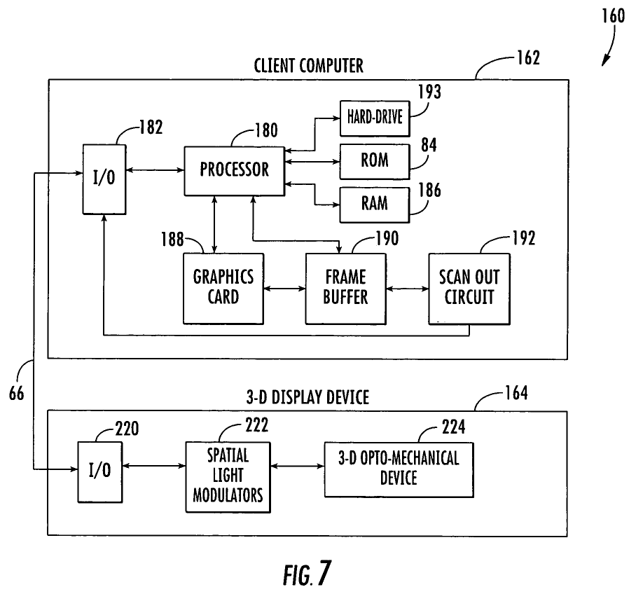

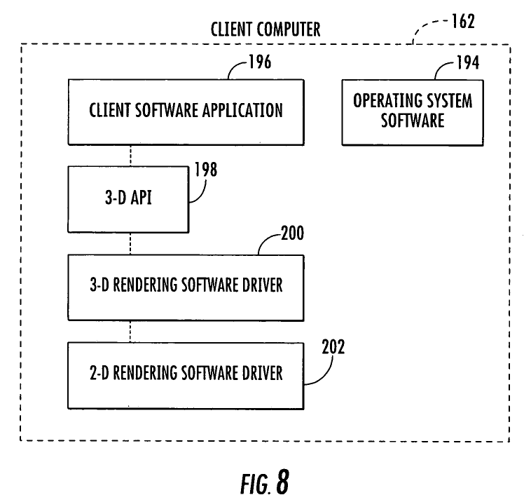

Referring to FIG. 7, a system 160 for generating rendering data associated with 3-D image is illustrated. The system 160 includes a client computer 162, a 3-D display device 164, and a communication bus 166.

The client computer 162 is provided to execute software algorithms for generating rendering data associated with one or more 3-D images. The client computer 162 includes a processor 180 operably coupled to an I/O interface 182, a ROM 184, a RAM 186, a graphics card 188, a frame buffer 190, a scan-out circuit 192, and a hard-drive 193. The I/O interface 182 is operably coupled between the processor 180 and the communication bus 166. The I/O interface 182 routes data from the processor 180 through the communication bus 166 to the 3-D display device 164. The ROM 184 and the RAM 186 are provided to store software algorithms utilized by the client computer 162. The graphics card 188 is provided to perform calculations for generating rendering data from 3-D data. In an alternate embodiment, the graphics card 188 can be replaced with any rendering hardware that is configured to generate 3-D rendering data. The frame buffer 190 is provided to store rendering data therein. The scan-out circuit 192 is provided to read the 3-D rendering data stored within the frame buffer 190 and to (i) transmit the rendering data through the I/O interface 182 and the communication bus 166 (ii) to store the 3-D rendering data in a non-volatile memory such as the hard-drive 193.

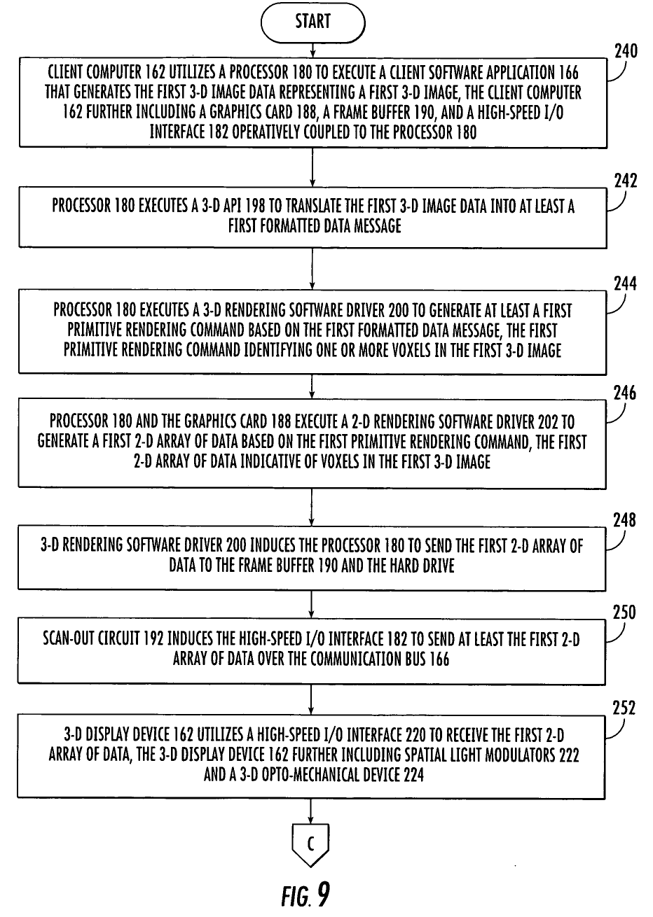

Referring to FIG. 8, the processor 180 executes the following software algorithms: (i) an operating system software 194, (ii) a client software application 196, (iii) a 3-D API 198, (iv) a 3-D rendering software driver 200, and (iv) a 2-D rendering software driver 202. The operating system software 194 facilitates execution of the client software application 196, the 3-D API 44, the 3-D rendering software driver 200, and the 2-D rendering software driver 202. The client software application 196 is provided to generate a 3-D image data representing one or more 3-D images. The 3-D API 198 is provided to format the 3-D image data into one or more formatted 3-D data messages for transmission through the communication bus 166. The communication software interface 196 is provided to induce the I/O interface 182 to transmit formatted 3-D data messages from the client computer 162 through the communication bus 166.

The communication bus 166 is provided transfer data messages between the client computer 162 and the 3-D display device 164. In one embodiment, the communication bus 166 comprises a PCX communication bus. Of course, in alternate embodiments, the communication bus 166 can comprise any bus capable of transmitting data between the computer 162 and the 3-D display device 164.

The 3-D display device 164 is provided to generate rendering data based on received formatted 3-D data messages and to display 3-D images thereon using the 3-D rendering data. The 3-D display device 164 includes an I/O interface 220, spatial light modulators 222, and a 3-D opto-mechanical device 224. The I/O interface 220 is operably coupled between the spatial light modulators 222 and the high-speed communication bus 166 and routes data received from the communication bus 166 to the spatial light modulators 222. The spatial light modulators 22 are provided to emit light based upon the rendering data that is utilized by the 3-D opto-mechanical device 224 to display 3-D images.

The 3-D opto-mechanical device 224 is provided to display images thereon. In one embodiment, the device 224 can comprise a multi-planar volumetric display device. For example, the device 224 can comprise the multi-planar volumetric display device taught in U.S. Pat. No. 6,554,430 that is incorporated herein by reference. In another embodiment, the device 224 can comprise a holographic display device. For example, the device 224 can comprise the holographic display device taught in U.S. Pat. No. 5,172,251 that is incorporated herein by reference. In another embodiment, the device 224 can comprise a multi-view or panoramagram display device. For example, the device 224 can comprise the multi-view or panoramagram display device taught in U.S. Pat. No. 6,850,210 that is incorporated herein by reference.

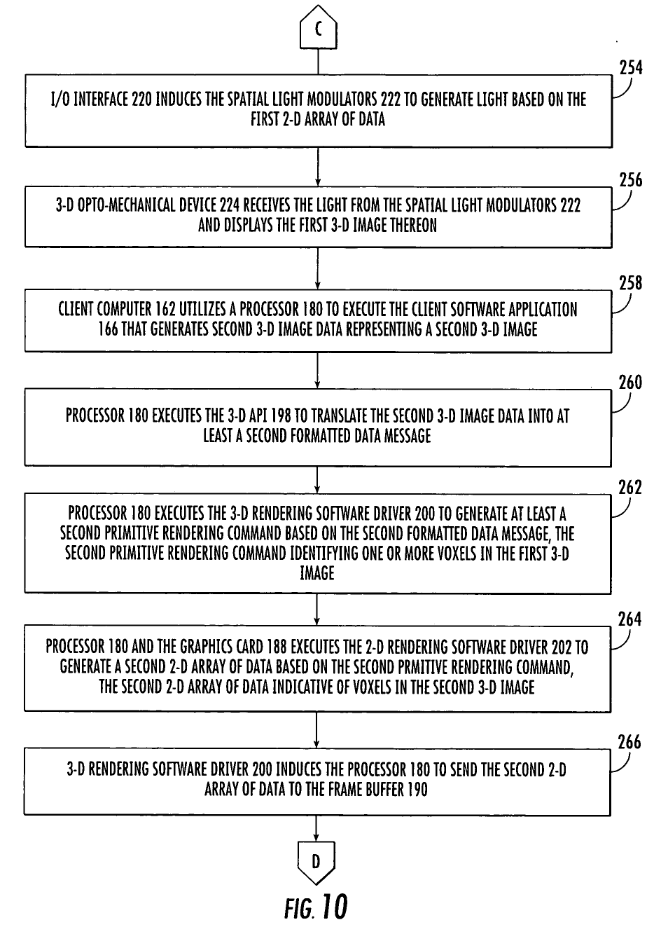

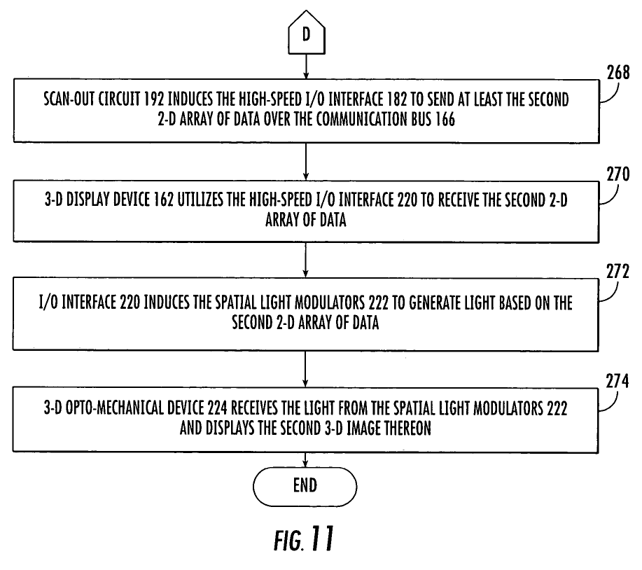

Referring to FIGS. 9-11, a method for generating rendering data associated with 3-D images will now be explained. The method can be implemented utilizing software algorithms executed in the system 160 described above.

At step 240, the client computer 162 utilizes a processor 180 to execute a client software application 166 that generates first 3-D image data representing a first 3-D image. The client computer 162 further includes the graphics card 188, the frame buffer 190, and the high-speed I/O interface 182 operatively coupled to the processor 180.

Next at step 242, the processor 180 executes a 3-D API 198 to translate the first 3-D image data into at least a first formatted data message.

Next at step 244, the processor 180 executes a 3-D rendering software driver 200 to generate at least a first primitive rendering command based on the first formatted data message. The first primitive rendering command identifies one or more voxels in the first 3-D image.

Next at step 246, the processor 180 and the graphics card 188 execute a 2-D rendering software driver 202 to generate a first 2-D array of data based on the first primitive rendering command. The first 2-D array of data is indicative of voxels in the first 3-D image.

Next at step 248, the 3-D rendering software driver 200 induces the processor 180 to send the first 2-D array of data to the frame buffer 190.

Next at step 250, the scan-out circuit 192 induces the high-speed I/O interface 182 to send at least the first 2-D array of data over the communication bus 166.

Next at step 252, the 3-D display device 162 utilizes a high-speed I/O interface 220 to receive the first 2-D array of data. The 3-D display device 162 further includes spatial light modulators 222 and the 3-D opto-mechanical device 224.

Next at step 254, the I/O interface 220 induces the spatial light modulators 222 to generate light based on the first 2-D array of data.

Next at step 256, the 3-D opto-mechanical device 224 receives the light from the spatial light modulators 222 and displays the first 3-D image thereon.

Next at step 258, the client computer 162 utilizes a processor 180 to execute the client software application 166 that generates second 3-D image data representing a second 3-D image.

Next at step 260, the processor 180 executes the 3-D API 198 to translate the second 3-D image data into at least a second formatted data message.

Next at step 262, the processor 180 executes the 3-D rendering software driver 200 to generate at least a second primitive rendering command based on the second formatted data message. The second primitive rendering command identifies one or more voxels in the first 3-D image.

Next at step 264, the processor 180 and the graphics card 188 execute the 2-D rendering software driver 202 to generate a second 2-D array of data based on the second primitive rendering command. The second 2-D array of data is indicative of voxels in the second 3-D image.

Next at step 266, the 3-D rendering software driver 200 induces the processor 180 to send the second 2-D array of data to the frame buffer 190.

Next at step 268, the scan-out circuit 192 induces the high-speed I/O interface 182 to send at least the second 2-D array of data over the communication bus 166.

Next at step 270, the 3-D display device 162 utilizes the high-speed I/O interface 220 to receive the second 2-D array of data.

Next at step 272, the I/O interface 220 induces the spatial light modulators 222 to generate light based on the second 2-D array of data.

Next at step 274, the 3-D opto-mechanical device 224 receives the light from the spatial light modulators 222 and displays the second 3-D image thereon. After step 274, the method is exited.

The system and the method for generating rendering data provides a substantial advantage over other systems and methods. In particular, the system has a technical effect of utilizing a 3-D rendering software driver, and a 2-D rendering software driver that communicates with a graphics card for generating a 2-D array of data based on a rendering command. Because the rendering software driver communicates with the rendering hardware (e.g., graphics card), the system generates rendering data faster that other systems and methods.

As described above, the present embodiments can be embodied in part in the form of computer-implemented processes and apparatuses for practicing those processes. The present embodiments can also be embodied in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the invention. The present embodiments can also be embodied in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the recited methods. When implemented on a general-purpose microprocessor, the computer program code segments configure the microprocessor to create specific logic circuits.

While embodiments of the invention are described with reference to the exemplary embodiments, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another. Furthermore, the use of the terms a, an, etc. do not denote a limitation of quantity, but rather denote the presence of at least one of the referenced items.

What is claimed is:

1. A system for generating rendering data associated with a 3-D image, comprising:
a 3-D API configured to generate a first 3-D data message indicative of one or more voxels in a first 3-D image from first 3-D image data;
a 3-D rendering software driver configured to receive the first 3-D data message from the 3-D API; and
a 2-D rendering software driver operably communicating with a 3-D rendering software driver and a rendering device, the 3-D rendering software driver configured to generate at least a first rendering command identifying one or more voxels in a slice of the first 3-D image, the 3-D rendering software driver sending the first rendering command to the 2-D rendering software driver, the 2-D rendering software driver configured to generate at least a first 2-D array of data based on the rendering command utilizing the rendering device.

2. The system of claim 1, further comprising a processor configured to execute the 3-D rendering software driver, the processor operably communicating with the rendering device; and a frame buffer configured to store the first 2-D array of data.

3. The system of claim 2, wherein the processor is further configured to store the first 2-D array of data in a non-volatile memory device.

4. The system of claim 2, wherein the processor is further configured to execute a communication software interface configured to receive the first 3-D data message from the 3-D API.

5. The system of claim 2, further comprising an operating system executing on the processor for facilitating operation of the 3-D rendering software driver and the 2-D rendering software driver with the rendering device and the frame buffer.

6. The system of claim 2, further comprising a scan-out circuit operably communicating with the frame buffer that reads the first 2-D array of data from the frame buffer.

7. The system of claim 6, further comprising optoelectronic devices operably communicating with the scan-out circuit and with a 3-D display device, the optoelectronic devices configured to generate light based on the first 2-D array of data.

8. The system of claim 7, further comprising a 3-D display device configured to receive the light from the optoelectronic devices and to generate the 3-D image based on the light.

9. The system of claim 8, wherein the 3-D display device comprises a 3-D opto-mechanical display device.

10. The system of claim 1, wherein the 3-D API is further configured to output a second 3-D data message indicative of one or more voxels in a first 3-D image from first 3-D image data, the 3-D rendering software driver further configured to receive the second 3-D data message from the 3-D API, and to generate at least a second rendering command identifying one or more voxels in a slice of the second 3-D image, the 3-D rendering software driver sending the second rendering command to the 2-D rendering software driver, the 2-D rendering software driver configured to generate at least a second 2-D array of data based on the second rendering command utilizing the rendering device.

11. The system of claim 1, wherein the 2-D rendering software driver and the 3-D rendering software driver are at least partially executed on a processor and the rendering device disposed in a 3-D display device.

12. The system of claim 1, wherein the 2-D rendering software driver and the 3-D rendering software driver are at least partially executed on a processor and the rendering device disposed in a first computer, the first computer configured to communicate with a 3-D display device via a communication bus.

13. A method for generating rendering data associated with a 3-D image, the method comprising:
generating a first 3-D data message indicative of one or more voxels in a first 3-D image from first 3-D image data, utilizing a 3-D API;
generating at least a first rendering command identifying one or more voxels in a slice of the first 3-D image based on the first 3-D message, utilizing a 3-D rendering software driver; and
generating at least a first 2-D array of data based on the first rendering command utilizing the 2-D rendering software driver and a rendering device.

14. The method of claim 13, further comprising storing the first 2-D array of data in a non-volatile memory.

15. The method of claim 13, further comprising storing the first 2-D array of data in a frame buffer.

16. The method of claim 15, further comprising reading the first 2-D array of data from the frame buffer utilizing a scan-out circuit.

17. The method of claim 16, further comprising:
generating light utilizing optoelectronic devices based on the 2-D array of data read by the scan-out circuit; and
generating a first 3-D digital image utilizing the 3-D display device based on the light from the optoelectronic devices.

18. The method of claim 17, wherein the 3-D display device comprises a 3-D opto-mechanical display device.

19. The method of claim 13, further comprising:
generating a second 3-D data message indicative of one or more voxels in a second 3-D image from second 3-D image data, utilizing the 3-D API;
generating at least a second rendering command identifying one or more voxels in a slice of the second 3-D image based on the second 3-D message, utilizing the 3-D rendering software driver; and
generating at least a second 2-D array of data based on the second rendering command utilizing the 2-D rendering software driver and the rendering device.

20. An article of manufacture, comprising:
a computer storage medium having a computer program encoded therein for generating rendering data associated with a 3-D image, the computer storage medium comprising:
code for a 3-D API that generates a first 3-D data message indicative of one or more voxels in a first 3-D image from first 3-D image data, utilizing a 3-D API;
code for a 3-D rendering software driver that generates at least a first rendering command identifying one or more voxels in a slice of the first 3-D image based on the first 3-D message; and
code for a 2-D rendering software driver that generates at least a first 2-D array of data based on the first rendering command.
